(19) United States
(12) Patent Application Publication
(10) Pub. No.: US 2026/0138596 A1
(43) Pub. Date: May 21, 2026

(54) DRIVING ASSISTANCE DEVICE

(71) Applicants: AISIN CORPORATION, Kariya (JP); HONDA MOTOR CO., LTD., Tokyo (JP)

(72) Inventors: Nozomu MAEDA, Kariya-shi (JP); Hiroki TAKAKU, Minato-ku (JP); Mizuki OWADA, Minato-ku (JP); Kazuya KOBAYASHI, Minato-ku (JP)

(73) Assignees: AISIN CORPORATION, Kariya (JP); Honda Motor Co., Ltd., Tokyo (JP)

(21) Appl. No.: 19/390,093

(22) Filed: Nov. 14, 2025

(30) Foreign Application Priority Data
Nov. 18, 2024 (JP) 2024-200511

(51) Int. Cl. B60W 30/06

(52) U.S. Cl. CPC B60W 30/06; B60W 2420/403; B60W 2554/801

(57) ABSTRACT

An obstacle is detected based on the result of detection by ultrasonic sensors included in the vehicle during parking assistance or parking exit assistance of the vehicle. In addition, a plurality of ultrasonic sensors is installed at the side face of the vehicle in a positional relationship in which indirect waves are not allowed to be received from each other, and in a case where a side obstacle is detected by the ultrasonic sensors at the time when parking assistance or parking exit assistance of the vehicle is started, the ultrasonic sensors are configured to restrict the approach to the side obstacle detected in a period from the start of parking assistance or parking exit assistance of the vehicle until a predetermined condition is satisfied.

### BACKGROUND OF THE INVENTION

### Field of the Invention

The present invention relates to a driving assistance device for assisting driving of a vehicle.

### Description of Related Art

In the related art, there has been proposed a driving assistance device that performs driving assistance by displaying a camera image obtained by capturing an image of an environment around a vehicle when the vehicle travels, giving a warning to a person or an obstacle located in the surroundings, or executing part or all of a driving operation by the vehicle instead of the user.

Here, as one example of driving assistance, parking assistance in which part or all of a driving operation when parking a vehicle is executed by the vehicle, or parking exit assistance in which part or all of a driving operation when exiting from a parking position is executed by the vehicle is known. For example, JP 2005-96703 proposes a driving assistance device in which, in a case where parking exit or parking of the vehicle is performed, a user outside the vehicle instructs the vehicle to move forward or backward using a terminal, and the vehicle moves while avoiding an obstacle detected by an obstacle detection unit in accordance with an instruction from the user.

### SUMMARY OF THE INVENTION

Here, as described in JP 2005-96703 A (paragraph 0035 to 0059), in a case where the user performs the parking assistance or the parking exit assistance by performing the terminal operation from the outside of the vehicle, basically, the parking or parking exit instruction is received in a state where the ignition of the vehicle is off. Therefore, the parking assistance or the parking exit assistance is started before the vehicle starts to move after the ignition is turned on.

On the other hand, as a means for detecting an obstacle around the vehicle, for example, a distance measurement sensor such as an ultrasonic sensor, a millimeter wave sensor, or a LiDAR sensor is used, and these distance measurement sensors perform detection while the vehicle is moving, so that the position of the obstacle can be accurately identified by triangulation. However, since triangulation is not established in a state before the vehicle starts to move after the ignition is turned on, the accuracy of detection of a surrounding obstacle decreases. Therefore, when parking assistance or parking exit assistance is started before the vehicle moves after the ignition is turned on, it is necessary to take this influence into account.

The present invention has been made to solve the above conventional problems, and an object of the present invention is to provide a driving assistance device capable of performing parking assistance or parking exit assistance in consideration of the above influence when there is an obstacle detected at the time of starting parking assistance or parking exit assistance of a vehicle.

In order to achieve the above object, a driving assistance device according to the present invention detects an obstacle based on a result of detection by a distance measurement sensor included in a vehicle during parking assistance or parking exit assistance of the vehicle, wherein the distance measurement sensor includes a plurality of the distance measurement sensors installed at a side face of the vehicle in a positional relationship in which indirect waves are not allowed to be received from each other, and wherein when a side obstacle is detected as the obstacle in a side direction of the vehicle by the distance measurement sensor at a time when parking assistance or parking exit assistance of the vehicle is started, the driving assistance device restricts approach to the side obstacle in a period from when the parking assistance or the parking exit assistance of the vehicle is started until a predetermined condition is satisfied.

According to the driving assistance device of the present invention having the above configuration, the approach to the obstacle detected at the side of the vehicle is restricted in the period from the start of the parking assistance or the parking exit assistance of the vehicle until the predetermined condition is satisfied. Therefore, even in a state where the accuracy of detection of the obstacle immediately after the start of the parking assistance or the parking exit assistance is lowered, the behavior of approaching the obstacle can be prevented from being performed.

### BRIEF DESCRIPTION OF THE DRAWINGS

FIG. 1 is a schematic configuration diagram of a vehicle according to the present embodiment;

FIG. 2 is a diagram illustrating an arrangement example of an ultrasonic sensor at a front face of a vehicle;

FIG. 3 is a diagram illustrating an arrangement example of an ultrasonic sensor at a side face of a vehicle;

FIG. 4 is a block diagram illustrating a configuration of a driving assistance device according to the present embodiment;

FIG. 5 is a flowchart of a driving assistance processing program according to the present embodiment;

FIG. 6 is a diagram illustrating a detection range in which an obstacle can be detected by an ultrasonic sensor installed in a vehicle;

FIG. 7 is a diagram illustrating an example of a case where a travel trajectory is generated without restricting the approach to the side obstacle detected at the time of starting the parking exit assistance;

FIG. 8 is a diagram illustrating a problem in a case where a travel trajectory is generated without restricting the approach to the side obstacle detected at the time of starting the parking exit assistance;

FIG. 9 is a diagram for describing a problem in a case of generating a travel trajectory without restricting the approach to the side obstacle detected at the time of starting the parking exit assistance;

FIG. 10 is a diagram illustrating an example of a case where the travel trajectory is generated by restricting the approach to the side obstacle detected at the time of starting the parking exit assistance;

FIG. 11 is a diagram illustrating detection of an obstacle using triangulation in an ultrasonic sensor;

FIG. 12 is a diagram illustrating an example of a case where the travel trajectory is generated by restricting the approach to the side obstacle detected at the time of starting the parking exit assistance;

FIG. 13 is a diagram illustrating a problem in a case where a travel trajectory is generated by limiting a limiting object limited only to a side obstacle detected by a specific ultrasonic sensor;

FIG. 14 is a diagram illustrating a problem in a case where a travel trajectory is generated by expanding a restriction for the side obstacles detected by all ultrasonic sensors;

FIG. 15 is a diagram for describing a problem in a case of generating a travel trajectory without restricting the approach to the side obstacle detected at the time of starting the parking assistance; and

FIG. 16 is a diagram for describing an example of a case where a travel trajectory is generated by restricting approach to the side obstacle detected at the time of starting the parking assistance.

### DETAILED DESCRIPTION OF PREFERRED EMBODIMENTS

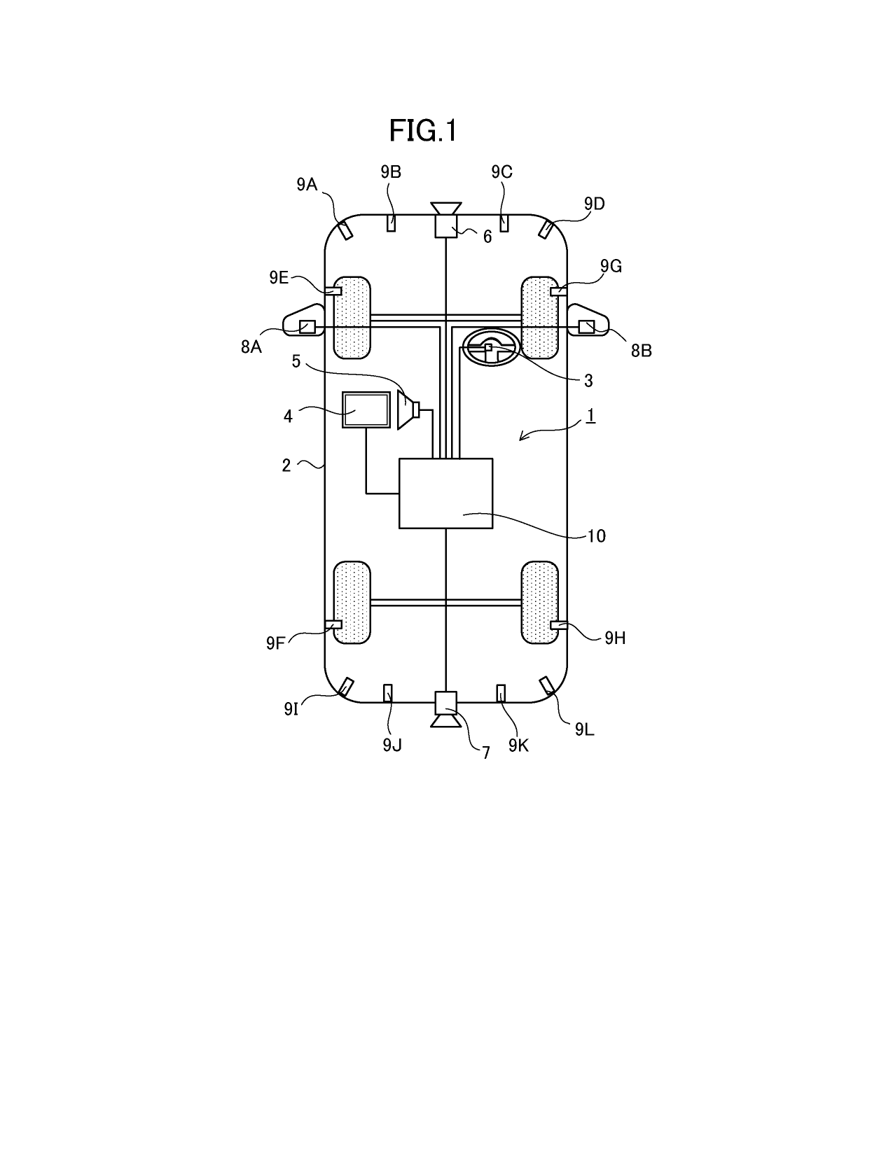

Hereinafter, a driving assistance device according to an embodiment of the present invention will be described in detail with reference to the drawings. First, a vehicle 2 on which a driving assistance device 1 according to the present embodiment is mounted will be described below. FIG. 1 is a schematic configuration diagram of a vehicle 2 according to the present embodiment.

Here, the vehicle 2 may be, for example, an automobile (internal combustion engine automobile) including an internal combustion engine (engine or the like) as a driving source, an automobile (electric vehicle, fuel cell vehicle, etc.) including an electric motor (motor or the like) as a driving source, or an automobile (hybrid automobile) including both of them as driving sources. In addition, the type of vehicle does not matter, the vehicle may be a normal vehicle, or may be a commercial large truck, a bus, a construction machine, or the like. In the following, a four-wheel vehicle is described, but a two-wheel or three-wheel vehicle may be described.

However, the vehicle 2 is such that in addition to the manual driving travel in which the vehicle travels based on the driving operation by the user, assisted driving can be performed by the automatic driving assistance in which the vehicle automatically travels regardless of the driving operation by the user.

Further, the automatic driving assistance may be performed only under a specific situation such as at the time of parking or at the time of exiting the parking slot, may be performed for all road sections, or may be performed only while the vehicle travels in a specific road section (for example, an expressway in which a gate (which does not matter whether manned or unmanned, or pay or free) is provided at a boundary). In the following description, the automatic driving section in which the automatic driving assistance of the vehicle is provided includes a parking lot in addition to all road sections including general roads and expressways, and is provided only in a situation where the user selects to provide the automatic driving assistance (for example, turns on the automatic driving start button) and it is determined that traveling with the automatic driving assistance is possible. On the other hand, the vehicle 2 may be a vehicle capable of performing only assistance travel by automatic driving assistance. Alternatively, the assistance travel by the automatic driving assistance may be performed only for traveling to the parking space when the vehicle is parked (that is, parking assistance) or traveling for exiting from the parking space (that is, parking exit assistance).

Then, in the vehicle control in the automatic driving assistance of the present embodiment, for example, the current position of the vehicle, the lane on which the vehicle travels, and the position of the surrounding obstacle are detected as needed, and the vehicle control such as steering, a driving source, and braking is automatically performed so that the vehicle travels along the generated travel trajectory at the speed according to the similarly generated speed plan. Specifically, the parking assistance and the parking exit assistance can be performed by the user operating the remote controller in a state of getting off the vehicle. The remote controller is, for example, an operation terminal capable of giving an instruction of "move forward" or "move backward". For example, when the user gives an instruction of "move forward", a surrounding situation is checked using a result of detection by a sensor or a camera as described later, a trajectory on which the vehicle moves forward is calculated from a current position of the vehicle, and vehicle control for moving the vehicle forward along the calculated trajectory to enter the parking space or for causing the vehicle to exit the parking space is automatically performed. On the other hand, when the user gives an instruction of "move backward", as described later, the surrounding situation is checked using the result of detection by the sensor and the camera, the trajectory of the vehicle moving backward from the current position is calculated, and vehicle control for moving the vehicle backward along the calculated trajectory to enter the parking space or causing the vehicle to exit the parking space is automatically performed. However, the parking assistance and the parking exit assistance are not limited to the above modes, and for example, it is possible to perform the parking assistance and the parking exit assistance in a state where the occupant gets on the vehicle, and it is possible to generate a trajectory to the parking position and the parking exit position by specifically designating the parking position and the parking exit position, and to cause the vehicle to automatically travel along the trajectory.

As illustrated in FIG. 1, the vehicle 2 includes an operation unit 3 that receives an operation from an occupant, a liquid crystal display 4 that displays a bird's-eye view image or an overhead view image around the vehicle and other information related to driving assistance to the occupant, a speaker 5 that outputs audio guidance related to driving assistance, a front camera 6, a rear camera 7, and side cameras 8A and 8B for imaging the surroundings of the vehicle, ultrasonic sensors 9A to 9L that detect the obstacle around the vehicle, and a driving assistance electronic control unit ECU (electric control unit) 10 that performs various types of arithmetic processing based on input information. Each component including the driving assistance ECU 10 is regarded as the driving assistance device 1.

Hereinafter, each component included in the vehicle 2 will be described. First, the operation unit 3 is disposed, for example, on a front face of a steering wheel, and includes an operation button or the like to be operated when automatic driving assistance is started. By operating the operation unit 3, the user can switch between the manual driving travel in which the vehicle travels based on the driving operation by the user and the assistance travel by the automatic driving assistance in which the vehicle automatically travels without depending on the driving operation by the user. The operation unit 3 may include a touch panel provided on the front face of the liquid crystal display 4. Further, a microphone and a voice recognition device may be provided. Furthermore, in the present embodiment, a remote controller (operation terminal) that can be operated from the outside of the vehicle to be described later is included as one of the operation units 3 to be operated by the occupant.

The liquid crystal display 4 is provided on an instrument panel of the vehicle 2, and displays a bird's-eye view image or an overhead view image around the vehicle generated by performing the viewpoint conversion and the synthesis process on captured images captured by the respective cameras of the front camera 6, the rear camera 7, and the side cameras 8A and 8B during execution of automatic driving assistance. When there is a warning object such as a pedestrian around the vehicle 2, a warning image indicating the presence of the warning object may be displayed at the position of the warning object in the bird's-eye view image or the overhead view image. Note that the liquid crystal display 4 may be used for a navigation device.

In addition, the speaker 5 is provided at an instrument panel of the vehicle 2, to output a guide voice, a warning sound, and the like related to driving assistance. Note that the speaker 5 may be used for a navigation device.

The front camera 6 is an imaging device including a camera including a solid-state imaging element such as a CCD, for example, and is installed, for example, above a front bumper of the vehicle 2 or on a back side of a room mirror with an optical axis direction facing forward in a traveling direction of the vehicle.

The rear camera 7 is an imaging device that includes a camera similarly including a solid-state imaging element such as a CCD, and is attached, for example, to the vicinity of the upper center of a number plate attached to the rear of vehicle 2, and is installed with an optical axis direction facing the rear of the vehicle.

Further, the side cameras 8A and 8B are imaging devices each including a camera similarly including a solid-state imaging element such as a CCD, and are attached, for example, to left and right mirrors of the vehicle 2, and are installed with an optical axis direction facing in the side direction of the vehicle.

Then, the driving assistance ECU 10 generates a bird's-eye view image or an overhead view image around the vehicle by performing the viewpoint conversion and the synthesis process on the captured images captured by the respective cameras of the front camera 6, the rear camera 7, and the side cameras 8A and 8B. In addition, during execution of automatic driving assistance, an image recognition process is performed on the captured image to detect a section line, a parking frame line, or an obstacle (another vehicle, a pedestrian, a bicycle, a wall, a guard rail, and another structure) around the vehicle, and automatic driving assistance is executed based on the result of detection. Specifically, in a case where parking assistance or parking exit assistance is performed, the situation of the parking space and the surroundings of the parking space are checked using the result of detection of the obstacle by the camera.

On the other hand, the ultrasonic sensors 9A to 9L are disposed at predetermined intervals at the front, rear, and side portions of the vehicle, transmit ultrasonic waves as probing waves to the surroundings of the vehicle 2, and receive reflected waves obtained by the transmitted probing waves being reflected by an object around the vehicle, thereby detecting the object reflecting the probing waves. Specifically, the sensor is a type of distance measurement sensor capable of detecting the distance (measurement distance) to the object reflecting the probing wave by measuring the time from transmission to reception. In addition, the ultrasonic sensors 9A to 9L are configured to be capable of generating an output signal (including the distance to the detected object) corresponding to the reception result of the received wave and outputting the generated output signal to the control unit. Examples of the object to be detected by the ultrasonic sensors 9A to 9L include an obstacle that is required to be avoided when the vehicle 2 travels, such as a person, a bicycle, another vehicle, or a wall, or an obstacle that forms a parking space. As the distance measurement sensor, a millimeter wave sensor or a LiDAR sensor may be used instead of the ultrasonic sensor.

In addition, the installation position and the installation direction of each of the ultrasonic sensors 9A to 9L can be set as appropriate, but, in the present embodiment, in order to set all directions of the front, rear, left, and right sides of the vehicle 2 in the traveling direction as the detection range of the object, for example, the ultrasonic sensors 9A to 9D are installed at the front face of the vehicle 2 toward the traveling direction so that the transmission direction of the probing wave matches the front of the vehicle in the traveling direction. The ultrasonic sensors 9E and 9F are installed leftward on the left side face of the vehicle 2 so that the transmission direction of the probing wave matched the left side of the vehicle with respect to the traveling direction. In addition, the ultrasonic sensors 9G and 9H are installed at the right face of the vehicle 2 in the right direction so that the transmission direction of the probing wave matches the right side of the vehicle with respect to the traveling direction. In addition, the ultrasonic sensors 9I to 9L are installed at the rear face of the vehicle 2 in a direction opposite to the traveling direction so that the transmission direction of the probing wave is directed behind the vehicle. The heights of the ultrasonic sensors 9A to 9L from the ground surface are substantially the same.

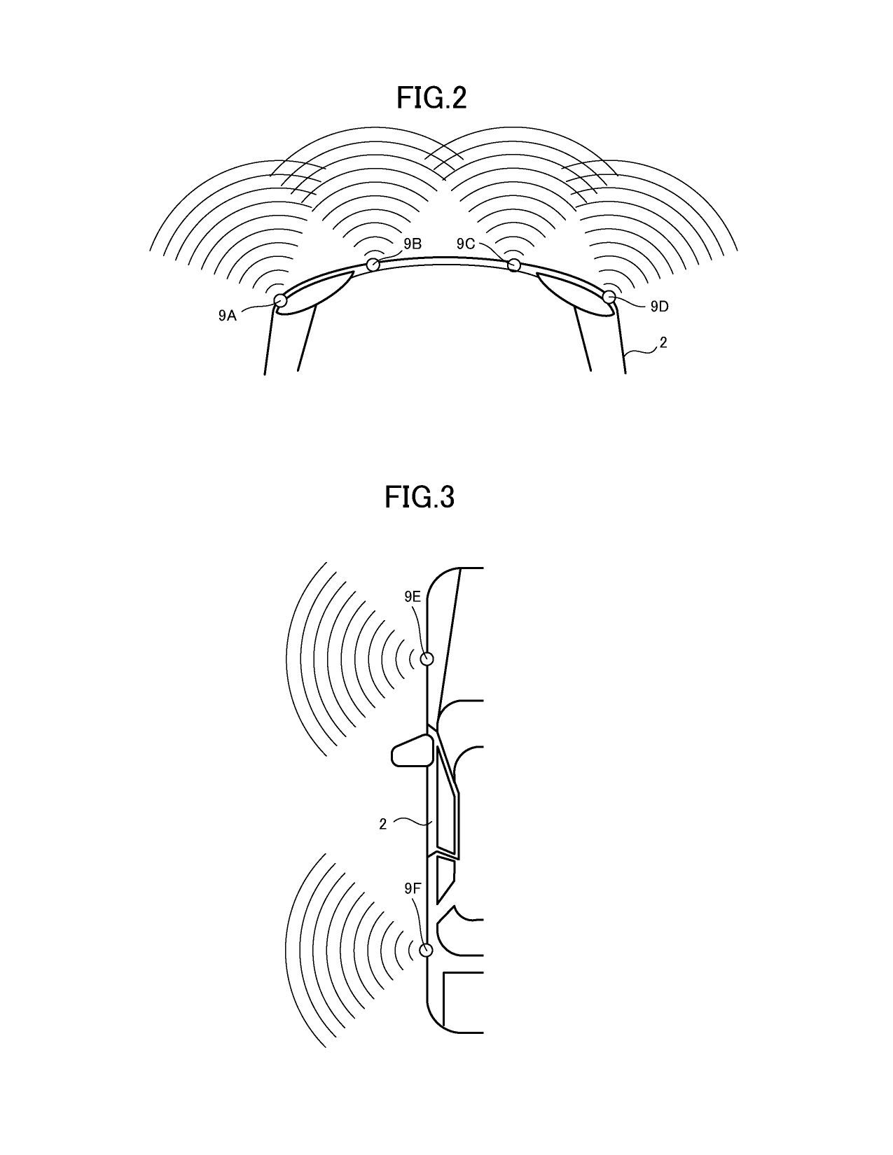

Specifically, when the ultrasonic sensors 9A to 9D will be described as an example, it is desirable that the ultrasonic sensors 9A to 9D be installed at different positions around the front bumper at the front face of the vehicle 2 or the front grille above the front bumper at equal intervals without being biased in the left-right direction as illustrated in FIG. 2, and be able to transmit the probing wave to a wider range in front of the vehicle (that is, the range in which the object is detectable is set to a wider range).

Specifically, as illustrated in FIG. 2, the ultrasonic sensor 9A is installed in a direction in which the transmission direction of the probing wave is inclined slightly leftward from the traveling direction of the vehicle 2 near the left front direction of the vehicle 2 so as to transmit the probing wave in left front of the vehicle 2. In addition, the ultrasonic sensor 9B is installed at the slightly left side of the center line of the vehicle 2 with the transmission direction of the probing wave facing in the traveling direction of the vehicle so as to transmit the probing wave in particularly left front of the vehicle 2. In addition, the ultrasonic sensor 9C is installed at the slightly right side of the center line of the vehicle 2 with the transmission direction of the probing wave facing in the traveling direction of the vehicle so as to transmit the probing wave in particularly right front of the vehicle 2. In addition, the ultrasonic sensor 9D is installed in a direction in which the transmission direction of the probing wave is inclined slightly rightward from the traveling direction of the vehicle 2 near the right front direction of the vehicle 2 so as to transmit the probing wave in right front of the vehicle 2. In addition, the ultrasonic sensor 9A and the ultrasonic sensor 9D are disposed symmetrically with respect to the vehicle center line in plan view and the ultrasonic sensor 9B and the ultrasonic sensor 9C are disposed symmetrically with respect to the vehicle center line in plan view. Although not illustrated, the same applies to the ultrasonic sensors 9I to 9L on the rear face of the vehicle 2, each of which is symmetrical in the vertical direction.

On the other hand, as illustrated in FIG. 3, the side ultrasonic sensors 9E and 9F are installed so as to transmit probing waves in a direction intersecting the traveling direction of the vehicle 2 by 90 degrees. Since the number of sensors installed in the range of the lateral side is smaller than that in the range of each of the front side and the rear side of the vehicle described above, there are areas in which the object cannot be directly detected by the ultrasonic sensors 9E and 9F, but, for these areas, the presence or absence of the object and the position of the object can be estimated from the detection history of the object by the ultrasonic sensors 9A to 9L. Although not illustrated, the same applies to the ultrasonic sensor 9G and the ultrasonic sensor 9H on the right face of the vehicle 2, each of which is symmetrical in the lateral direction.

In the present embodiment, among the ultrasonic sensors 9A to 9L, in particular, the ultrasonic sensors 9A to 9D on the front face of the vehicle 2 and the ultrasonic sensors 9I to 9L on the rear face of the vehicle 2 are installed at positions where reflected waves as indirect waves can be received between adjacent sensors. Therefore, by receiving a direct wave and an indirect wave as received waves, it is possible to identify not only a distance to the object but also a specific position (relative position with respect to the vehicle) of the object using triangulation. Since the side ultrasonic sensors 9E to 9H are installed to be away from each other, indirect waves are not allowed to be received, but since the vehicle moves, a specific position (relative position with respect to the vehicle) of the object is allowed to be identified by triangulation using the measurement distance at the previous position, the measurement distance at the current position, and the movement distance between the previous position and the current position.

On the other hand, the driving assistance ECU 10 is an electronic control unit that performs various processes related to automatic driving assistance. For example, the ECU 10 detects a current position of the vehicle, a lane on which the vehicle travels, and a position of the surrounding obstacle as needed, and performs vehicle control such as steering, a driving source, and braking so that the vehicle travels along the generated travel trajectory at a speed according to the similarly generated speed plan. Specifically, in a case where parking assistance or parking exit assistance is performed, using the result of detection by the front camera 6, the rear camera 7, the side cameras 8A and 8B, and the ultrasonic sensors 9A to 9L described above, vehicle control in which a parking space in which the vehicle is to be parked and a situation around the parking space are checked, a trajectory for forward movement or backward movement instructed by the occupant is calculated, and the vehicle is caused to enter the parking space or leave the parking space along the calculated trajectory. The liquid crystal display 4 may display a landscape (real view) around the vehicle, and when a warning object such as a pedestrian is present around the vehicle, a warning image indicating the presence of the warning object may be displayed in a superimposed manner at the position of the warning object in the landscape. The driving assistance ECU 10 is connected to the operation unit 3, the liquid crystal display 4, the speaker 5, the front camera 6, the rear camera 7, the side cameras 8A and 8B, and the ultrasonic sensors 9A to 9L described above via an in-vehicle network such as CAN. Further, the ECU 10 is connected to various sensors such as a vehicle speed sensor, an acceleration sensor, a gyro sensor, a steering sensor, and a shift position sensor, which are mounted on the vehicle 2, a navigation device which is an in-vehicle device, and the like. A detailed configuration of the driving assistance ECU 10 will be described later.

Although the vehicle 2 includes basic components as the vehicle 2 in addition to the components illustrated in FIG. 1, only a configuration related to control of automatic driving assistance and control related to the configuration will be described.

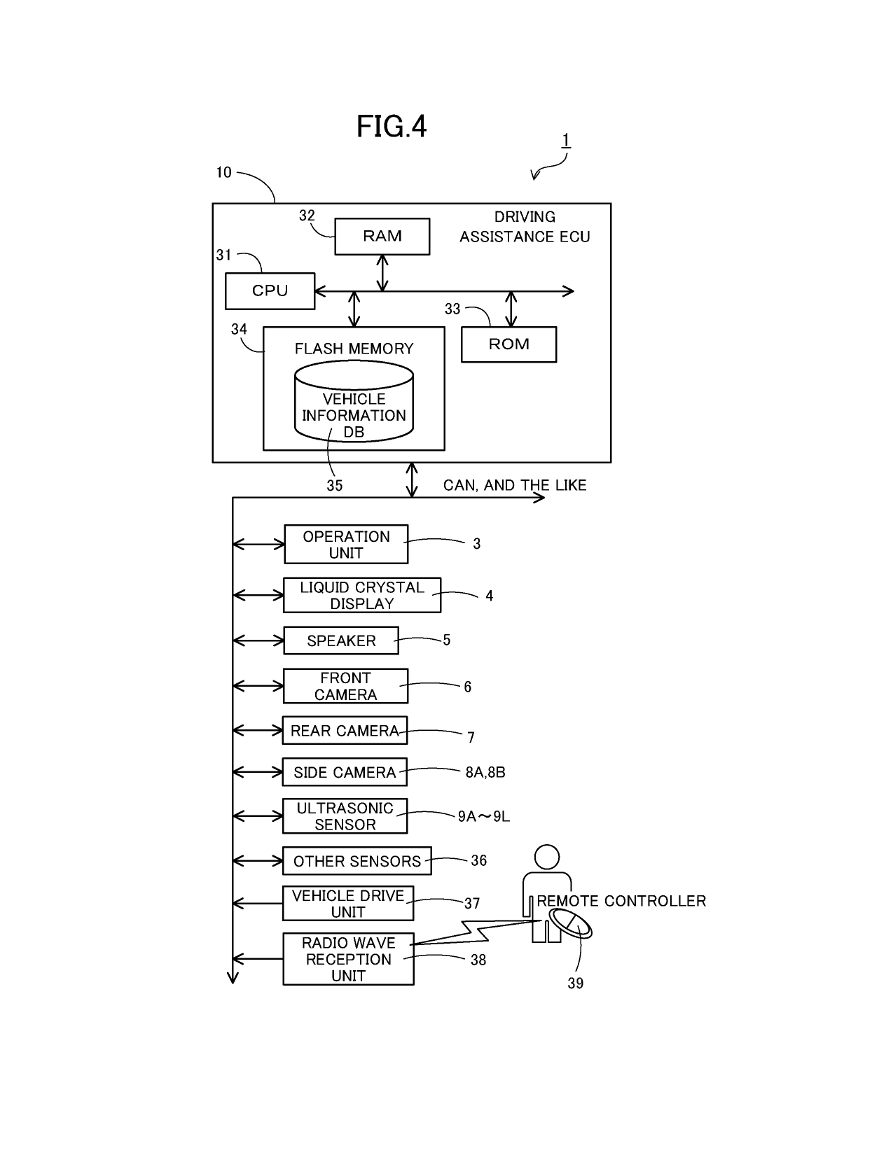

Next, details of the driving assistance ECU 10 in the driving assistance device 1 included in the above-described vehicle 2 will be described. FIG. 4 is a block diagram illustrating a configuration of the driving assistance device 1 according to the present embodiment.

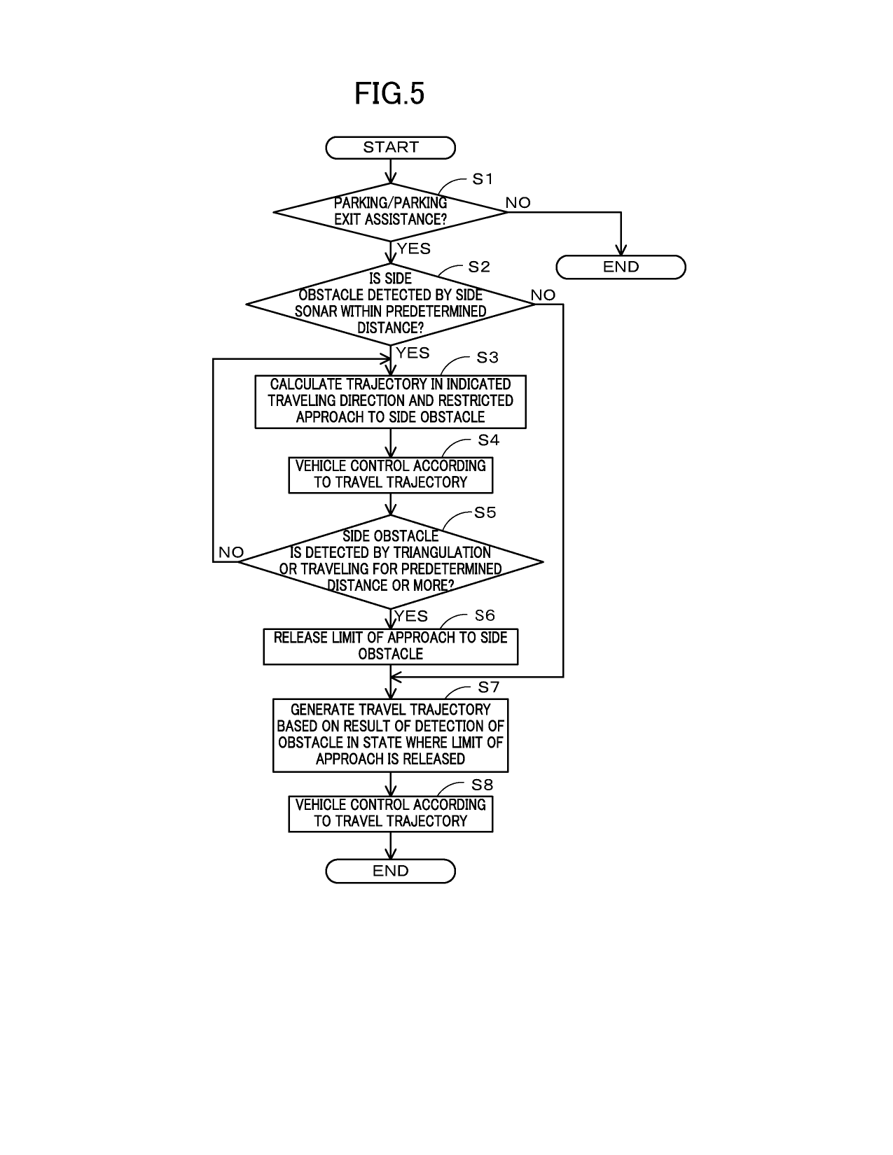

As illustrated in FIG. 4, the driving assistance ECU (electronic control unit) 10 is an electronic control unit that performs overall control of the driving assistance device 1, and includes a CPU 31 as an arithmetic device and a control device, and internal storage devices such as a RAM 32 that is used as a working memory when the CPU 31 performs various types of arithmetic processing and that stores travel trajectory data and the like when a travel trajectory is calculated, a ROM 33 that stores a driving assistance processing program (see FIG. 5) and the like to be described later in addition to a program for control, and a flash memory 34 that stores a program read from the ROM 33. The driving assistance ECU 10 executes various functions as a processing algorithm. For example, in a case where an obstacle located in the side direction of the vehicle 2 is detected by the ultrasonic sensors 9E to 9H at the time when the parking assistance or the parking exit assistance of the vehicle is started, the various functions includes a function of restricting the approach to the obstacle located in the side direction of the vehicle 2 detected in a period from the start of the parking assistance or the parking exit assistance of the vehicle until the predetermined condition is satisfied.

The driving assistance ECU 10 is connected to various sensors 36 for detecting the behavior of the vehicle, such as a vehicle speed sensor, an acceleration sensor, a gyro sensor, a steering sensor, and a shift position sensor, and respective drive units 37 of the vehicle, such as a steering, a brake, an accelerator, and a transmission, and performs automatic driving assistance of the vehicle 2 by controlling the respective drive units 37 while detecting the current behavior of the vehicle based on the result of detection by these sensors 36. As a specific content of the automatic driving assistance, for example, a current position of the vehicle, a lane on which the vehicle travels, and a position of a surrounding obstacle are detected as needed, and vehicle control such as steering, a driving source, and braking is performed so that the vehicle travels along the generated travel trajectory at a speed according to the similarly generated speed plan. However, only the steering operation may be automatically performed, and the drive source and the brake may be controlled based on the manual operation.

The driving assistance ECU 10 is connected to a radio wave reception unit 38 that transmits and receives radio waves to and from a remote controller 39, which is a type of operation terminal possessed by the occupant. The radio wave reception unit 38 is a device that receives radio waves emitted from the remote controller 39. The remote controller 39 includes, for example, two buttons of "move forward" and "move backward" as operation buttons, and the driving assistance ECU 10 can detect that the occupant has operated either "move forward" or "move backward" using the radio wave reception unit 38. Specifically, in the present embodiment, in performing the parking assistance and the parking exit assistance of the vehicle, when the user instructs the traveling direction (direction in which the vehicle exits from the parking space when the vehicle exits, and a direction in which the vehicle enters the parking space when the vehicle is parked) of the vehicle, the user gives an instruction of "move forward" or "move backward" using the remote controller 39. Note that the remote controller may be used as an electronic key for unlocking the door. Alternatively, a smartphone carried by the occupant in a communicably connected state with the vehicle 2 may be the remote controller 39.

In addition, the flash memory 34 includes a vehicle information DB 35, and the vehicle information DB 35 stores various types of information about the vehicle 2. For example, installation positions (height from ground surface, position in horizontal direction) and detection axes (optical axes for cameras) of the cameras and the ultrasonic sensors 9A to 9L installed in the vehicle 2, a total length, a vehicle width, a wheel base, a minimum turning radius, and the like are stored. These pieces of information are input in advance by an occupant or a person of the vehicle manufacturer.

Next, a driving assistance processing program executed by the driving assistance ECU 10 in the driving assistance device 1 having the above configuration will be described with reference to FIG. 5. FIG. 5 is a flowchart of a driving assistance processing program according to the present embodiment. Here, the driving assistance processing program is a program that is executed after an accessory power supply (ACC power supply) of the vehicle 2 is turned on, and particularly performs parking assistance and parking exit assistance as one type of automatic driving assistance. Note that the program illustrated in the flowchart in FIG. 5 below is stored in the RAM 32 or the ROM 33 included in the driving assistance device 1, and is executed by the CPU 31.

First, in step (hereinafter, abbreviated as S) 1, the CPU 31 determines whether to start parking assistance or parking exit assistance. In the present embodiment, the CPU 31 determines to start either the parking assistance or the parking exit assistance when detecting that the occupant operates either "move forward" or "move backward" with the remote controller 39 using the radio wave reception unit 38. The occupant may be in a state of getting on the vehicle or in a state of getting off the vehicle. In the following description, it is assumed that the occupant is in a state of getting off the vehicle when performing parking assistance and parking exit assistance.

In the present embodiment, when the vehicle is parked or is caused to exit, the user instructs the vehicle to move forward or backward without designating whether the vehicle is parked or is caused to exit. For example, in a case where the vehicle is caused to exit in a state of being parked forward in the parking space, the user gives an instruction of "move forward", and in a case where the vehicle is caused to exit in a state of being parked backward in the parking space, the user gives an instruction of "move backward". On the other hand, in a case where the vehicle is moved forward and parked in the parking space, the user gives an instruction of "move forward", and in a case where the vehicle is moved backward and parked in the parking space, the user gives an instruction of "move backward". Then, the driving assistance device 1 automatically moves the vehicle in the instructed direction, and as a result, performs parking and exiting. That is, in the present embodiment, the driving assistance device 1 performs the same control after S2 without distinguishing the parking assistance from the parking exit assistance.

However, the conditions for starting the parking assistance and the parking exit assistance are not limited to the operation of the remote controller 39, and may be, for example, a condition that an occupant operates the operation unit 3 in the vehicle in a state of getting on the vehicle. In addition, in a case where it is detected that the vehicle has entered the parking lot, the parking assistance may be automatically started when it is determined that the vehicle has arrived at a set destination, or when the vehicle has approached the parking lot, and the parking exit assistance may be started on condition that the ignition is turned on.

Then, when it is determined to start either the parking assistance or the parking exit assistance (S1: YES), the process proceeds to S2. On the other hand, when it is determined that neither the parking assistance nor the parking exit assistance is started (S1: NO), the driving assistance processing program is terminated.

In S2, the CPU 31 determines whether an obstacle has been detected by any of the ultrasonic sensors 9E to 9H (side sonars) that are installed at the side face of the vehicle, in particular, and whose detection range covers the side direction of the vehicle among the ultrasonic sensors 9A to 9L, at the current time, that is, at the time of starting the parking assistance or the parking exit assistance of the vehicle. Specifically, it is desirable to set as a condition that the measurement distance, which is a distance to the detected obstacle, is within a predetermined detection distance.

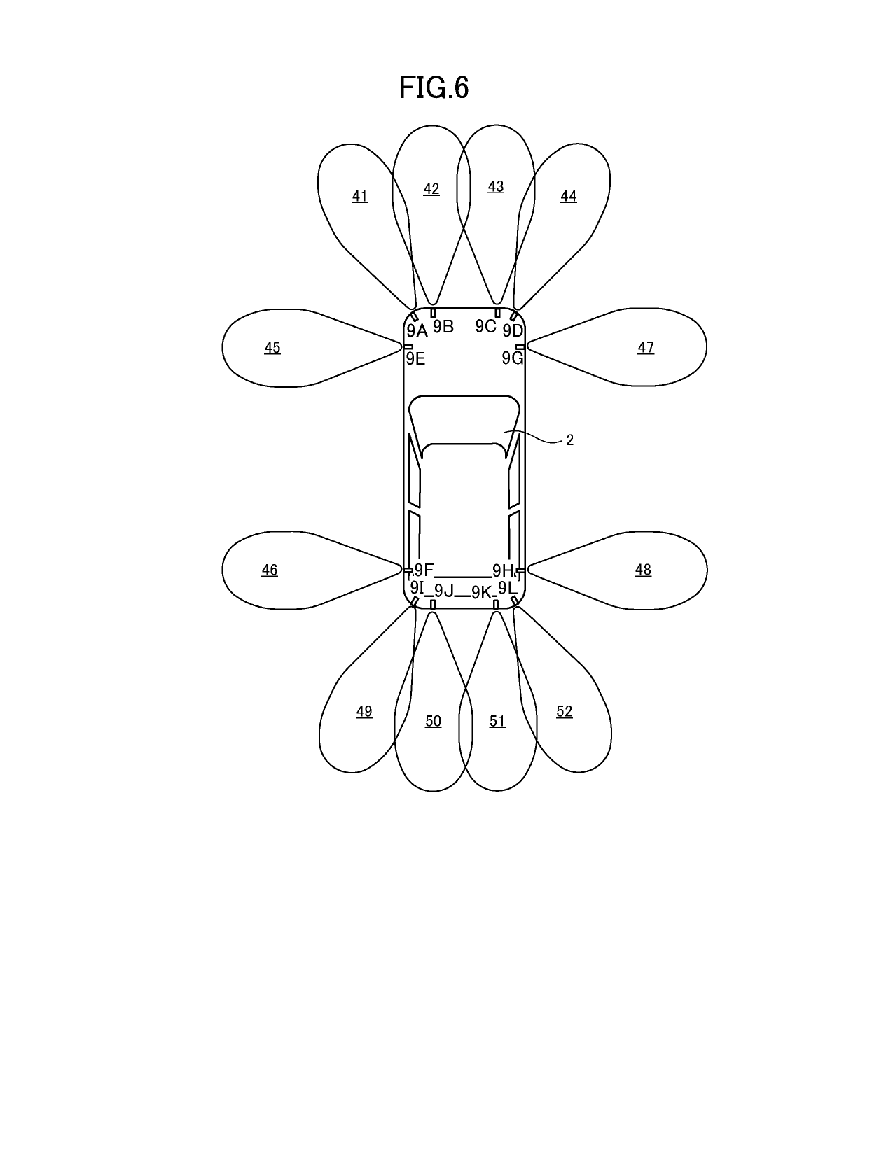

Here, the ultrasonic sensors 9A to 9L transmit ultrasonic waves as probing waves to the surroundings of the vehicle 2 as described above, and receive reflected waves obtained by the transmitted probing waves being reflected by an object around the vehicle, thereby detecting the object reflecting the probing waves (FIGS. 2 and 3). In the present embodiment, a plurality of ultrasonic sensors is disposed in the vehicle, but the range to which the probing wave can be transmitted is limited, and further, even when the probing wave is reflected by an obstacle, the reflected wave is received only when the probing wave is reflected by an obstacle located at a relatively short distance (for example, within 5 m) from the ultrasonic sensors 9A to 9L. Similarly, reflected waves are not allowed to be received for an obstacle at a position largely away from the detection axis of the ultrasonic sensor in the left-right direction. Specifically, as illustrated in FIG. 6, each of the detection ranges 41 to 52 in which an obstacle can be detected by the ultrasonic sensors 9A to 9L are a substantially elliptical range. As described above, each of the detection range 41 to 52 is limited, and the obstacle that can be detected by the ultrasonic sensors 9A to 9L is basically limited to an obstacle located at a position considerably close to the host vehicle. Specifically, in order to detect an obstacle located in the side direction of the vehicle, the obstacle is required to be located in the detection ranges 45 to 48, and the host vehicle is required to be located close to the side of the obstacle to be detected.

Therefore, detecting an obstacle by the ultrasonic sensors 9E to 9H in S2 means that an obstacle is present in any of the detection ranges 45 to 48, a reflected wave reflected by the obstacle is received, and a measurement distance that is a distance from the sensor to the obstacle is allowed to be identified. In addition, the measurement distance is calculated from the time from the transmission of the probing wave to the reception of the reflected wave. Note that the detection distance serving as the additional determination condition of S2 is, for example, 40 cm, but the distance can be appropriately changed. However, it is desirable that the distance be longer than an allowable distance (a distance to an obstacle allowable in generation of the travel trajectory) to be described later.

Here, as will be described later, since the vehicle moves, the ultrasonic sensors 9E to 9H can identify the specific position of the object by triangulation using the measurement distance at the previous position, the measurement distance at the current position, and the movement distance between the previous position and the current position, but the above triangulation is not established at the time of S2 since the vehicle has not started to move. In addition, as illustrated in FIG. 3, since the ultrasonic sensors 9E to 9H are disposed away from each other and cannot receive an indirect wave, triangulation using an indirect wave is not established, and a specific position of an obstacle cannot be identified. Therefore, in S2, the ultrasonic sensors 9E to 9H detect an obstacle only by a direct wave. In the detection using only the direct wave, the distance to the obstacle can be known, but it is difficult to identify the specific position and shape of the obstacle.

Then, when it is determined that the ultrasonic sensors 9E to 9H detect an obstacle and the measurement distance, which is the distance to the detected obstacle, is within the predetermined detection distance (S2: YES), the process proceeds to S3. An obstacle located in the side direction of the vehicle 2, the obstacle being determined to be detected by the ultrasonic sensors 9E to 9H in S2, is hereinafter also referred to as a side obstacle. On the other hand, when it is determined that the ultrasonic sensors 9E to 9H do not detect an obstacle, or even when detected, when it is determined that the measurement distance, which is the distance to the obstacle, is outside the predetermined detection distance (S2: NO), the process proceeds to S7.

In S3, the CPU 31 calculates a travel trajectory for the vehicle traveling from the current position in the traveling direction designated by the occupant. As described above, the occupant can give an instruction of either "move forward" or "move backward" by the remote controller 39. When "move forward" is instructed, a travel trajectory moving forward from the current position of the vehicle is calculated. When "move backward" is instructed, a travel trajectory moving backward from the current position of the vehicle is calculated.

Note that, in the case of generating the travel trajectory of the vehicle, the travel trajectory is basically generated based on the result of detection of the obstacle by the camera and the ultrasonic sensors 9A to 9L. As described above, the ultrasonic sensors 9A to 9L can detect the obstacle in the detection range 41 to 52 (FIG. 6). Although the detailed position is allowed to be identified using triangulation, triangulation cannot be used for the ultrasonic sensors 9E to 9H whose detection range is the side of the vehicle at the time when parking assistance or parking exit assistance is started. On the other hand, in the detection of the obstacle by the front camera 6, the rear camera 7, and the side cameras 8A and 8B, it is possible to detect the obstacle by performing image recognition on captured images captured by the respective cameras. The obstacle to be detected is an obstacle that hinders traveling of the vehicle, and it does not matter whether the obstacle is a moving object or a stationary object. For example, a pedestrian, another vehicle, a wall, and the like correspond to the object. As processing of detecting an obstacle from the captured image, for example, binarization processing of performing luminance correction on the road surface and an obstacle on the road surface based on a luminance difference and then separating the obstacle from the image, geometric processing of correcting distortion, smoothing processing of removing noise of the image, and the like are performed, and a boundary line between the road surface and the obstacle can be detected. Note that the type of the obstacle may be detected using known template matching processing, feature point detection processing, or the like. Furthermore, the image recognition process on the captured image is not limited to the above example, and may be performed using, for example, machine learning. The camera described above detects the obstacle in a wider detection range than the ultrasonic sensors 9A to 9L, and even an obstacle located far from the host vehicle can be detected as an obstacle if the obstacle is included in the captured image. On the other hand, there is a problem that the camera has lower detection accuracy than the ultrasonic sensors 9A to 9L.

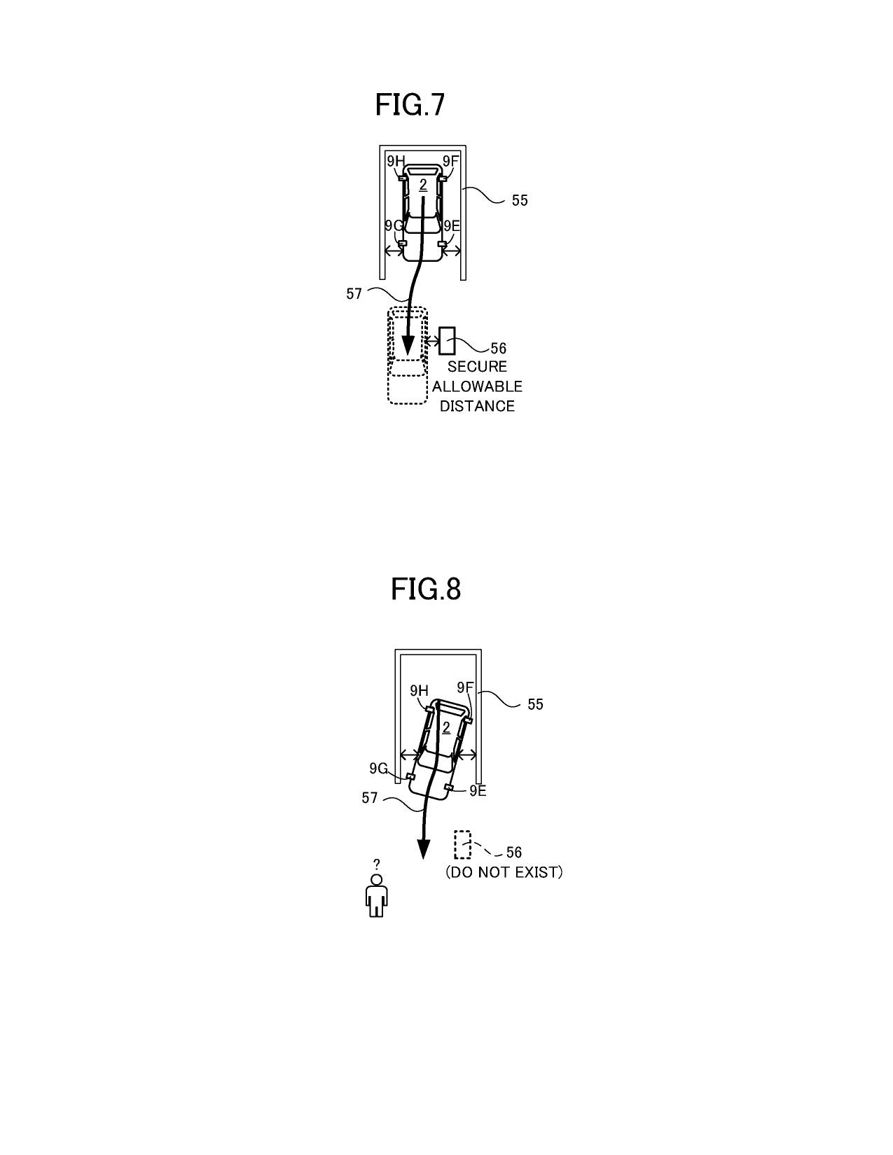

Here, in the generation of the travel trajectory of the vehicle, basically, in a case where an obstacle is detected around the vehicle in the detection of the obstacle by the camera and the ultrasonic sensors 9A to 9L, it is assumed that a travel trajectory in which the distance from the vehicle to the obstacle is constantly maintained at a predetermined allowable distance (for example, 20 cm) or more is generated. For example, in a case of performing parking exit assistance for causing a vehicle parked in a garage 55 to exit by moving forward as illustrated in FIG. 7, when an obstacle 56 is detected in front of the vehicle in the traveling direction, the travel trajectory 57 for turning slightly rightward with respect to straight traveling is generated in order to maintain the distance equal to or longer than the allowable distance with respect to the obstacle 56. The turning trajectory may be a clothoid curve or an arc, but a curve that can be drawn by the vehicle is generated based on the vehicle information (wheelbase or the like) stored in the vehicle information DB 35. Note that, in a case where a travel trajectory for securing an allowable distance or more with respect to an obstacle cannot be generated, for example, in a case where there is an obstacle in front of the vehicle in the traveling direction, or the like, the assistance is stopped.

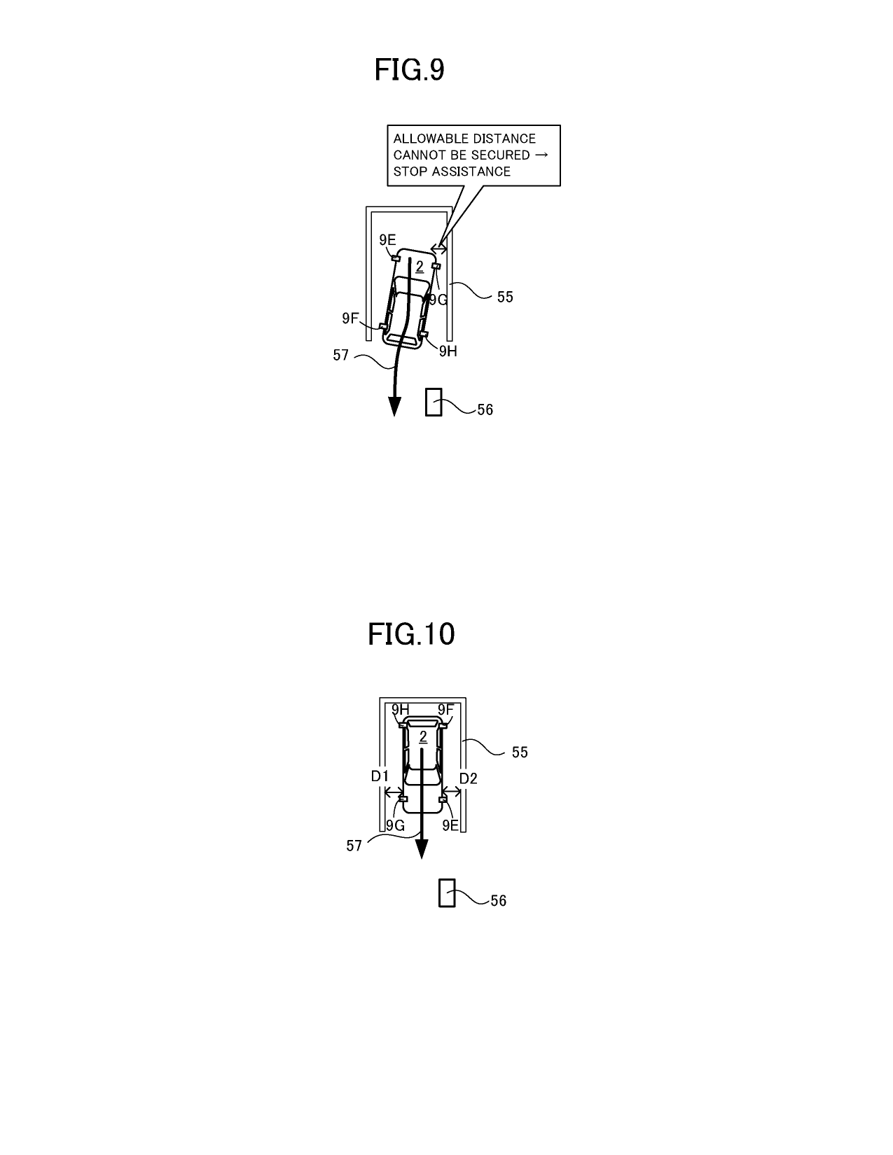

As described above, the camera is used to detect the obstacle, but, since the accuracy of detection of the obstacle by the camera is lower than that of the ultrasonic sensors 9A to 9L, the presence or absence and the position of the obstacle may be erroneously detected. For example, as illustrated in FIG. 8, there may be a case where it is erroneously detected that the obstacle 56 exists at a position where the obstacle does not actually exist. In this case, in particular, as illustrated in FIG. 8, in a case where there is a wall of the garage 55 which is an obstacle close to the left or right side of the vehicle, when the travel trajectory 57 for turning immediately after the start of the assistance is generated, the behavior of the vehicle that cannot be understood by the occupant, such as approaching the wall of the garage 55 in order to avoid the obstacle 56 which does not exist occurs, resulting in the occupant having a concern. Furthermore, in particular, as illustrated in FIG. 9, in the case of exiting from the parking slot by "move backward", it is conceivable that the distance between the front of the vehicle and the wall of the garage 55 is close due to the outer ring difference by the travel trajectory for turning from the beginning, and thereafter, the travel trajectory securing the allowable distance or more to the wall of the garage 55 cannot be generated (a state in which the trajectory cannot be corrected and the vehicle cannot move), and the assistance is forcibly terminated. Although the description is omitted, the same situation can occur even in the inner ring difference at the time of forward movement.

Therefore, in the present embodiment, in order to avoid the situation illustrated in FIGS. 8 and 9, in the generation of the travel trajectory in S3, in a case where a side obstacle is detected by the ultrasonic sensors 9E to 9H at the time of starting the parking assistance or the parking exit assistance of the vehicle (S2: YES), the approach to the side obstacle detected in the period from the start of the parking assistance or the parking exit assistance of the vehicle until the condition of S5 is satisfied thereafter is restricted. That is, in a case where the walls of the garage 55 are present on the left and right sides at the time of starting the parking assistance or the parking exit assistance of the vehicle as illustrated in FIG. 10, a travel trajectory in which the distance D1 to the right wall and the distance D2 to the left wall detected by the ultrasonic sensors 9E to 9H are not shorter than the current distance, that is, a travel trajectory 57 in which the vehicle goes straight between the walls and exits from the garage 55 is generated. Specifically, even when it is detected that an obstacle (an obstacle different from a side obstacle) exists in the traveling direction of the vehicle by a sensor or a camera whose detection range is the traveling direction of the vehicle, the approach to the side obstacle is restricted. Note that the sensor or the camera whose detection range is the traveling direction of the vehicle corresponds to the ultrasonic sensors 9A to 9D or the front camera 6 whose detection range is a range in front of the vehicle when the vehicle 2 moves forward. On the other hand, when the vehicle 2 is moving backward, the sensor or the camera correspond to the ultrasonic sensors 9I to 9L or the rear camera 7 whose detection range is a range behind the vehicle thereto. Note that, in the example illustrated in FIG. 10, when the vehicle travels straight, the vehicle comes into contact with the obstacle 56 in the traveling direction. However, since the restriction is released after the vehicle travels straight for a certain period as described later, the travel trajectory 57 for turning to avoid the obstacle 56 is finally generated (S7).

Note that FIG. 10 illustrates an example of a case where walls of the garage 55, which are side obstacles located left and right of the vehicle, are detected at the time when parking assistance or parking exit assistance of the vehicle is started. For example, in a case where there is a wall only on one side, generation of a trajectory for turning in a direction away from the wall, in addition to generation of a travel trajectory for going straight, is allowed.

Thereafter, in S4, the CPU 31 starts parking assistance or parking exit assistance in accordance with the travel trajectory calculated in S3. Specifically, the current position of the host vehicle is detected as needed, and vehicle control such as steering, a driving source, and braking is automatically performed so as to travel at a designated speed along the generated travel trajectory.

Note that the process of S3 and S4 is repeatedly executed every time the vehicle travels a predetermined distance unit (for example, 50 cm) until a determination condition of S5 described later is satisfied. That is, each time the vehicle travels a predetermined distance unit, a travel trajectory in which the approach to the side obstacle is restricted is generated, and control of causing the vehicle to travel according to the generated travel trajectory is repeatedly performed.

Subsequently, in S5, the CPU 31 determines whether at least one of the following conditions (A) and (B) is satisfied.

(A) The positions of the side obstacles detected by the ultrasonic sensors 9E to 9H at the time of starting the parking assistance or the parking exit assistance of the vehicle is allowed to be identified by triangulation.

(B) The vehicle has traveled a predetermined distance (for example, 1m) after the parking assistance or the parking exit assistance of the vehicle is started.

In the present embodiment, it is determined whether at least one of the conditions (A) and (B) is satisfied, but it may be determined that both conditions are satisfied. Alternatively, it may be determined whether any one of the conditions (A) and (B) is satisfied.

Then, after it is determined that at least one of the conditions (A) and (B) is satisfied (S5: YES), the restriction on the approach to the side obstacle set in S3 is released (S6).

Thereafter, in S7, the CPU 31 calculates a travel trajectory for traveling from the current position of the vehicle in the traveling direction designated by the occupant. Basically, the processing is similar to that in S3, but the restriction on the approach to the side obstacle detected by the ultrasonic sensors 9E to 9H is released at the time when the parking assistance or the parking exit assistance of the vehicle is started, and the travel trajectory is generated. However, although the restriction on the approach is released, the condition naturally includes maintaining the distance to the side obstacle detected at the time of starting the assistance (including the obstacle detected thereafter) at an allowable distance (for example, 20 cm) or more.

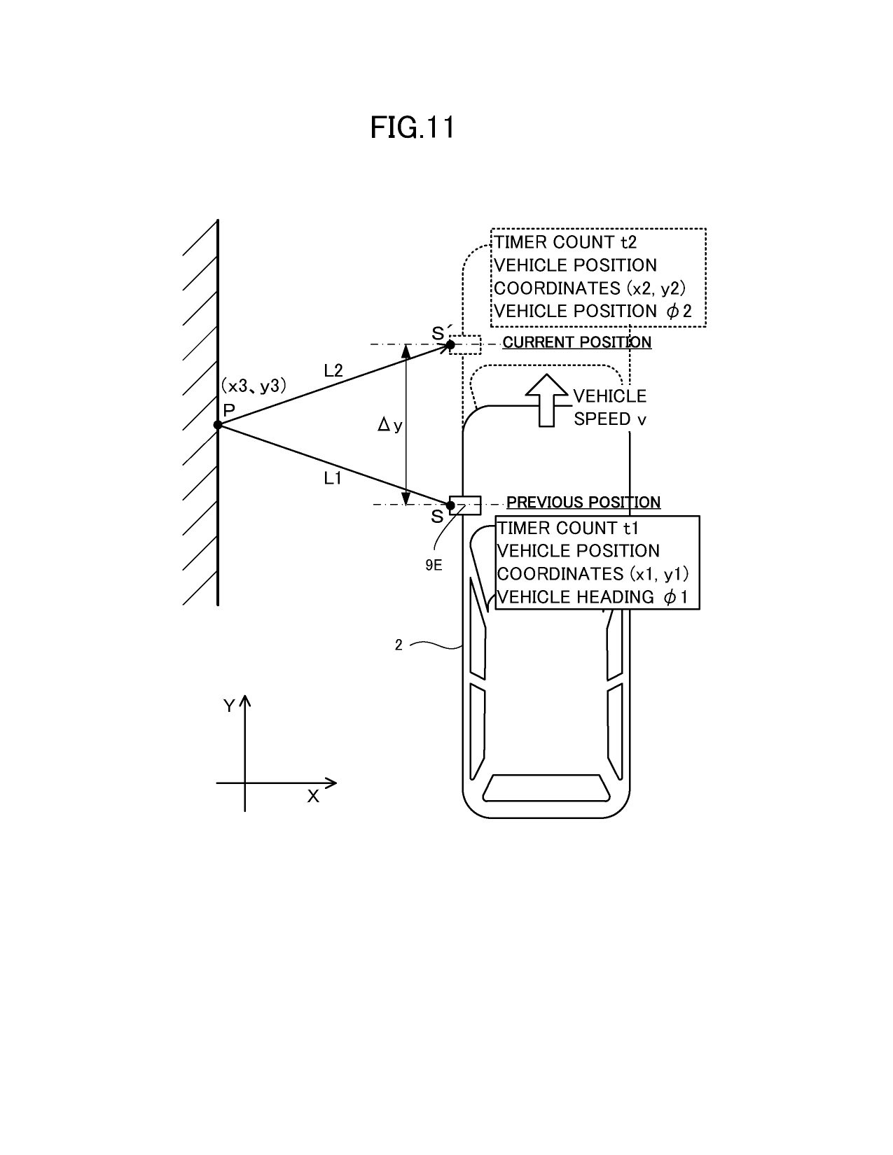

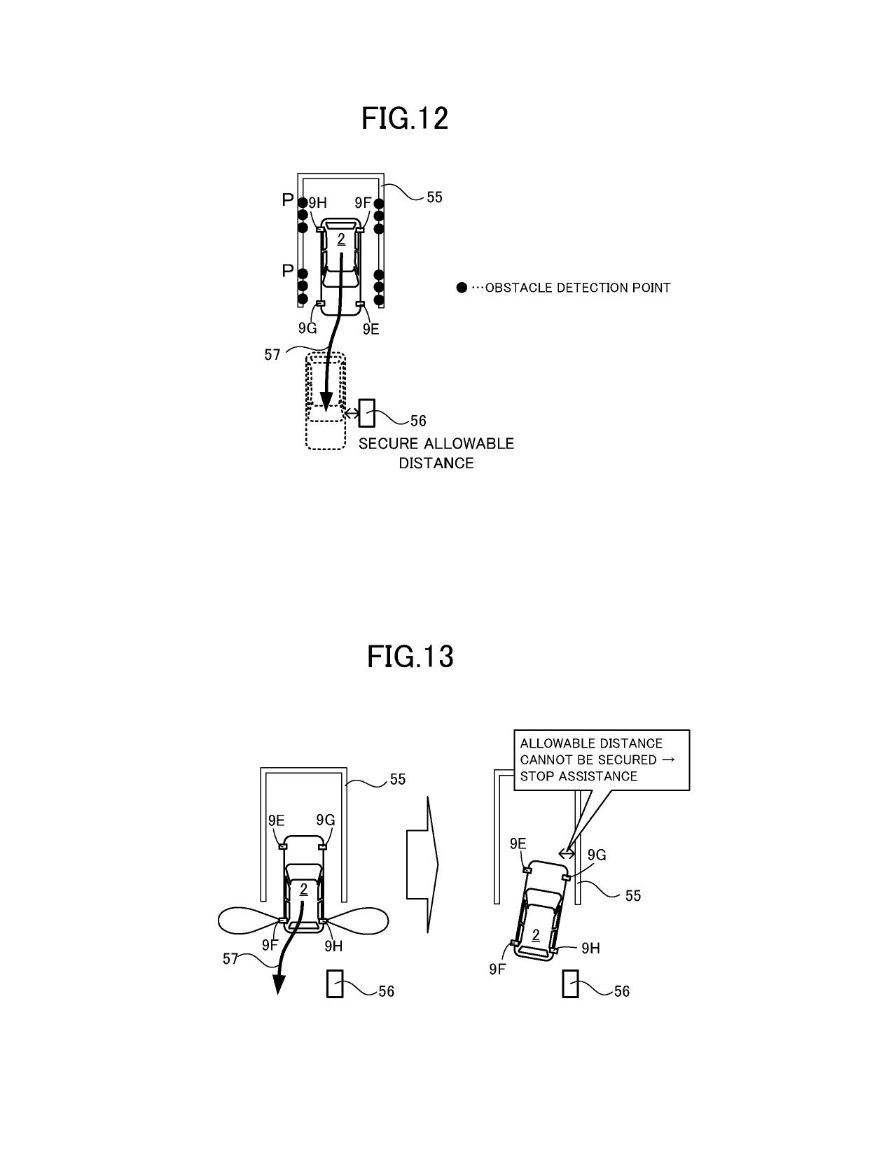

Here, the above condition (A) will be described in more detail. In a case where an obstacle is identified using the result of detection by the ultrasonic sensors 9E and 9F or the ultrasonic sensors 9G and 9H installed in the side direction of the vehicle 2, the vehicle moves, since the vehicle moves, the specific position of the obstacle is allowed to be identified by triangulation using the measurement distance at the previous position, the measurement distance at the current position, and the movement distance between the previous position and the current position. Specifically, first, as illustrated in FIG. 11, the CPU 31 acquires various pieces of vehicle information at the timing when the reflected wave is received by the ultrasonic sensor 9E or 9F or the ultrasonic sensor 9G or 9H at the previous position. Specific examples of the vehicle information to be acquired include a vehicle speed v, current position coordinates (x1, y1) of the host vehicle, and a vehicle azimuth φ1. These pieces of information are identified using, for example, a vehicle speed sensor, a gyro sensor, a steering sensor, and the like. The count value t1 of the timer that identifies the timing at which the reflected wave is received at the previous position is acquired. Next, the CPU 31 similarly acquires various pieces of vehicle information at the timing when the reflected wave is received by the ultrasonic sensor 9E or 9F or the ultrasonic sensor 9G or 9H at the current position. Specific examples of the vehicle information to be acquired include the vehicle speed v (it is assumed that the vehicle speed does not change because the transmission interval of the probing wave is short), current position coordinates (x2, y2) of the host vehicle, a vehicle azimuth φ2, a count value t2 of the timer, and the like, which are similar to the previous position. When the reflected wave is not allowed to be received within a predetermined time (for example, until the next transmission timing of the ultrasonic wave) after the transmission of the ultrasonic wave, it is determined that the obstacle cannot be detected. Note that the previous position and the current position basically correspond to timings at which continuous probing waves are received in time series, but for example, there may be a break between the previous position and the current position may not be continuous but may be spaced. Thereafter, the CPU 31 calculates the measurement distance based on the time interval from the transmission of the probing wave at each of the previous position and the current position to the reception of the reflected wave reflected by the object, and stores the calculated measurement distance in association with the acquired vehicle information. As illustrated in FIG. 11, the measurement distance calculated by the ultrasonic sensor is a distance L1 from the sensor position S of the vehicle 2 at the previous position to the reflection point P where the reflected wave is reflected, and a distance L2 from the sensor position S’ of the vehicle 2 at the current position to the reflection point P where the reflected wave is reflected. Thereafter, the CPU 31 calculates a movement distance Δy of the host vehicle from the previous position to the current position based on the vehicle speed v of the host vehicle during the distance measurement. Then, by triangulation using the measurement distance L1 of the previous position, the measurement distance L2 of the current position, and the movement distance Δy between the previous position and the current position in consideration of the vehicle information about the previous position and the vehicle information about the current position, coordinates (x3, y3) of the reflection point P where the reflected wave is reflected are calculated. Note that the above calculation example is an example, and it is possible to calculate the coordinates (x3, y3) of the reflection point P using another method. Then, the CPU 31 stores the calculated coordinates (x3, y3) of the reflection point P as point sequence data in the flash memory 34 or the like. The coordinates (x3, y3) of the reflection point P identify the position of the obstacle (more specifically, the position of the surface forming the outer shape of the obstacle), and the shape (surface) of the obstacle can also be accurately identified by connecting the point sequence data of the point P as illustrated in FIG. 12.

Therefore, the case where the condition (A) is satisfied in S5 means that the accurate position and shape of the side obstacle (for example, the wall of the garage 55 in the example illustrated in FIG. 12), which has been detected only to exist closer to the ultrasonic sensors 9E to 9H at the time of starting the parking assistance or the parking exit assistance of the vehicle, is allowed to be identified by triangulation. After such a state, even when the obstacle 56 is detected and a trajectory for avoiding the obstacle 56 is generated as illustrated in FIG. 12, it is possible to avoid the travel trajectory for turning immediately after the start of the assistance. In addition, as illustrated in FIG. 8, even when the obstacle 56 that does not exist is detected due to erroneous detection by the camera, the trajectory in which the vehicle comes close to the wall of the garage 55 immediately after the start of the assistance is not formed, and the occupant does not have a concern. Furthermore, since the travel trajectory is generated in a state in which the position and the shape of the wall of the garage 55 detected in the left and right direction of the vehicle from the time of starting the assistance can be accurately identified to some extent, it is possible to prevent the assistance from being forcibly terminated in a state in which the trajectory cannot be corrected and the vehicle cannot move as illustrated in FIG. 9.

Further, in the present embodiment, a plurality of ultrasonic sensors 9E to 9H whose detection range is a range in a side direction of the vehicle is installed at different positions with respect to the vehicle. In a case where a side obstacle is detected by the ultrasonic sensors 9E to 9H installed in the vehicle at the time of starting parking assistance or parking exit assistance of the vehicle, it is desirable that the condition (A) is that the position of the side obstacle is allowed to be identified by triangulation using a measurement distance using the foremost ultrasonic sensor in the traveling direction of the vehicle (for example, the ultrasonic sensor 9E and the ultrasonic sensor 9G in the example illustrated in FIG. 12) among the plurality of ultrasonic sensors 9E to 9H that has detected the side obstacle. This is because it is important in generating the travel trajectory of the vehicle that the position of the side obstacle at the traveling direction side location relative to the side obstacle in the direction opposite to the traveling direction of the vehicle (for example, the shape near the entrance of the garage 55 in the example illustrated in FIG. 12) is allowed to be identified.

However, the condition (A) may be a condition that the position of the side obstacle is allowed to be identified by triangulation using the measurement distance for all the ultrasonic sensors (for example, the ultrasonic sensors 9E to 9H in the example illustrated in FIG. 12) that have detected the side obstacle at the time of starting the parking assistance or the parking exit assistance of the vehicle.

On the other hand, the condition (B) in S5 is set for the purpose of providing an upper limit on the distance for which the vehicle moves with the approach to the side obstacle limited, because, for example, triangulation accompanying the vehicle movement described in FIG. 11 is not established for some reason, and there is a possibility that an obstacle (obstacle 56 illustrated in FIG. 12) in the traveling direction of the vehicle to be avoided cannot be avoided if the vehicle continues to travel straight. That is, even when the triangulation associated with the movement of the vehicle is not established, the restriction on the approach to the side obstacle detected by the ultrasonic sensors 9E to 9H at the time when the vehicle has traveled a predetermined distance from the start of the assistance is released, and the travel trajectory is generated. When the vehicle travels a predetermined distance (for example, 1 m) after the start of the parking assistance or the parking exit assistance of the vehicle, even if the obstacle 56 is detected and then a turning trajectory is formed as illustrated in FIG. 12, it is possible to prevent the travel trajectory for making a turn immediately after the start of the assistance from being formed. In addition, as illustrated in FIG. 8, even when the obstacle 56 that does not exist is detected due to erroneous detection by the camera, the trajectory in which the vehicle comes close to the wall of the garage 55 immediately after the start of the assistance is not formed, and the occupant does not have a concern. In the present embodiment, the predetermined distance is 1 m, but may be a distance other than 1 m.

Thereafter, in S8, the CPU 31 starts parking assistance or parking exit assistance in accordance with the travel trajectory generated in S7. Specifically, the current position of the host vehicle is detected as needed, and vehicle control such as steering, a driving source, and braking is automatically performed so as to travel at a designated speed along the generated travel trajectory.

As a result of the process of S3 to S8 described above, first, as illustrated in FIG. 10, the vehicle 2 goes straight for a certain period on a trajectory on which the vehicle 2 does not approach the wall of the garage 55, which is the left and right side obstacles detected at the time of starting the assistance (for example, a straight trajectory, but when there is only one wall, a trajectory on which the vehicle 2 turns in a direction away from the one wall may be used). Thereafter, in a case where the obstacle 56 is detected in the traveling direction of the vehicle in the detection of the obstacle by the camera and the ultrasonic sensors 9A to 9L, the restriction on the approach to the wall of the garage 55 is released, and as illustrated in FIG. 12, a travel trajectory in which the distance from the vehicle 2 to the obstacle 56 and the distance to the wall of the garage 55 are maintained at a predetermined allowable distance (for example, 20 cm) or more is generated. For example, as illustrated in FIG. 12, a trajectory turning to the right side is generated in order to avoid the obstacle 56.

Note that the process of S7 and S8 is repeatedly executed every time the vehicle travels a predetermined distance unit (for example, 50 cm) until the parking assistance or the parking exit assistance is completed. That is, every time the vehicle travels a predetermined distance unit, a travel trajectory is generated based on the result of detection of the obstacle, and control of causing the vehicle to travel according to the generated travel trajectory is repeatedly performed.

The condition that the parking assistance or the parking exit assistance is completed may be a condition that the vehicle has traveled a predetermined distance from the start of the assistance, or may be a condition that the occupant instructs the end of the assistance with a remote controller. The completion condition of the parking exit assistance may be a condition that no obstacle is detected around the vehicle. The completion condition of the parking assistance may be a condition that the vehicle is in a state where the vehicle cannot move further in the direction instructed by the occupant (for example, when a wall or the like is detected in the traveling direction).

In addition, in the present embodiment, as illustrated in FIG. 6, a plurality of ultrasonic sensors 9E to 9H whose detection range is a range in a side direction of the vehicle 2 is installed at different positions with respect to the vehicle 2. In a case where a side obstacle is detected by at least one or more ultrasonic sensors among the plurality of ultrasonic sensors 9E to 9H installed in the vehicle at the time when parking assistance or parking exit assistance of the vehicle is started, it is desirable to generate a travel trajectory for restricting the approach to the side obstacle detected by each of all the ultrasonic sensors, each ultrasonic sensor having detected the side obstacle, in S3.

Here, when it is assumed that a travel trajectory in which the approach to the side obstacle detected only by the foremost ultrasonic sensor in the traveling direction of the vehicle is restricted in S3 is generated, the following problem occurs. That is, as illustrated in FIG. 13, the foremost ultrasonic sensors in the traveling direction of the vehicle are the ultrasonic sensor 9F and the ultrasonic sensor 9H, and when the parking exit assistance is started in a state where part of the vehicle is out of the garage 55, the ultrasonic sensor 9F and the ultrasonic sensor 9H do not detect a side obstacle at the time of starting the assistance, so that the restriction of S3 is not performed, and the travel trajectory is generated in S7 immediately after the start of the assistance. As a result, for example, when the obstacle 56 is detected in the traveling direction of the vehicle as illustrated in FIG. 13, the travel trajectory 57 that turns to avoid the obstacle 56 immediately after the start of the assistance is generated. As a result, it is conceivable that the distance between the front of the vehicle and the wall of the garage 55 approaches due to the outer ring difference, and thereafter, the travel trajectory securing the allowable distance or more with respect to the wall of the garage 55 cannot be generated (a state in which the trajectory cannot be corrected and the vehicle cannot move), and the assistance is forcibly terminated.

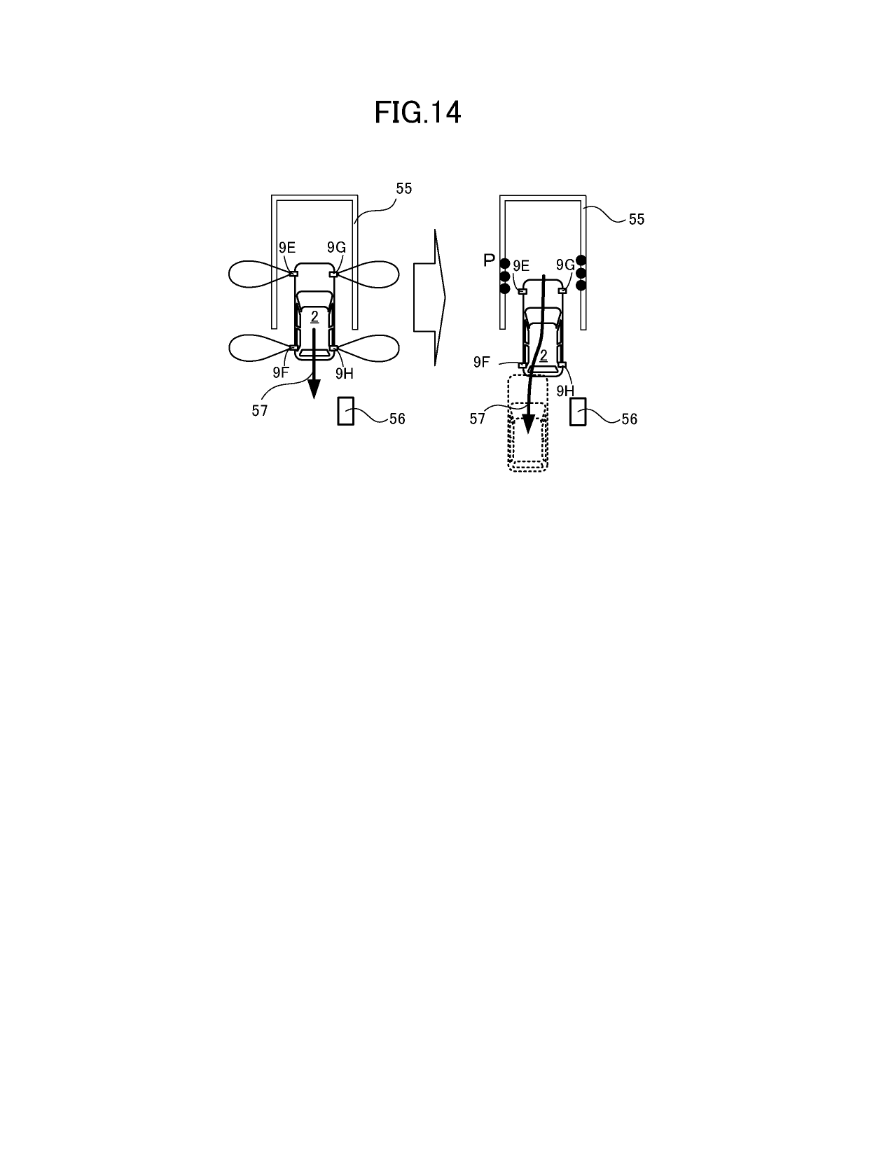

On the other hand, the above problem is solved by generating a travel trajectory for restricting the approach to the side obstacle detected by each of all the ultrasonic sensors, each ultrasonic sensor having detected the side obstacle, in S3. That is, even in a case where the parking exit assistance is started in a state where part of the vehicle has jumped out of the garage 55 as illustrated in FIG. 14, the ultrasonic sensor 9E and the ultrasonic sensor 9G located in the direction opposite to the traveling direction side detect the wall of the garage 55, which is a side obstacle, at the time of starting the assistance. Therefore, immediately after the start time point of assistance, a travel trajectory is generated in which the approach to the wall of the garage 55 is restricted in S3. As a result, for example, even in a case where the obstacle 56 is detected in the traveling direction of the vehicle as illustrated in FIG. 14, the travel trajectory in which the approach to the wall of the garage 55 is restricted is generated until the condition of S5 is satisfied. Therefore, the travel trajectory 57 that turns to avoid the obstacle 56 is not generated immediately after the start of the assistance, and the travel trajectory 57 that turns to avoid the obstacle 56 after the condition of S5 is satisfied is generated.

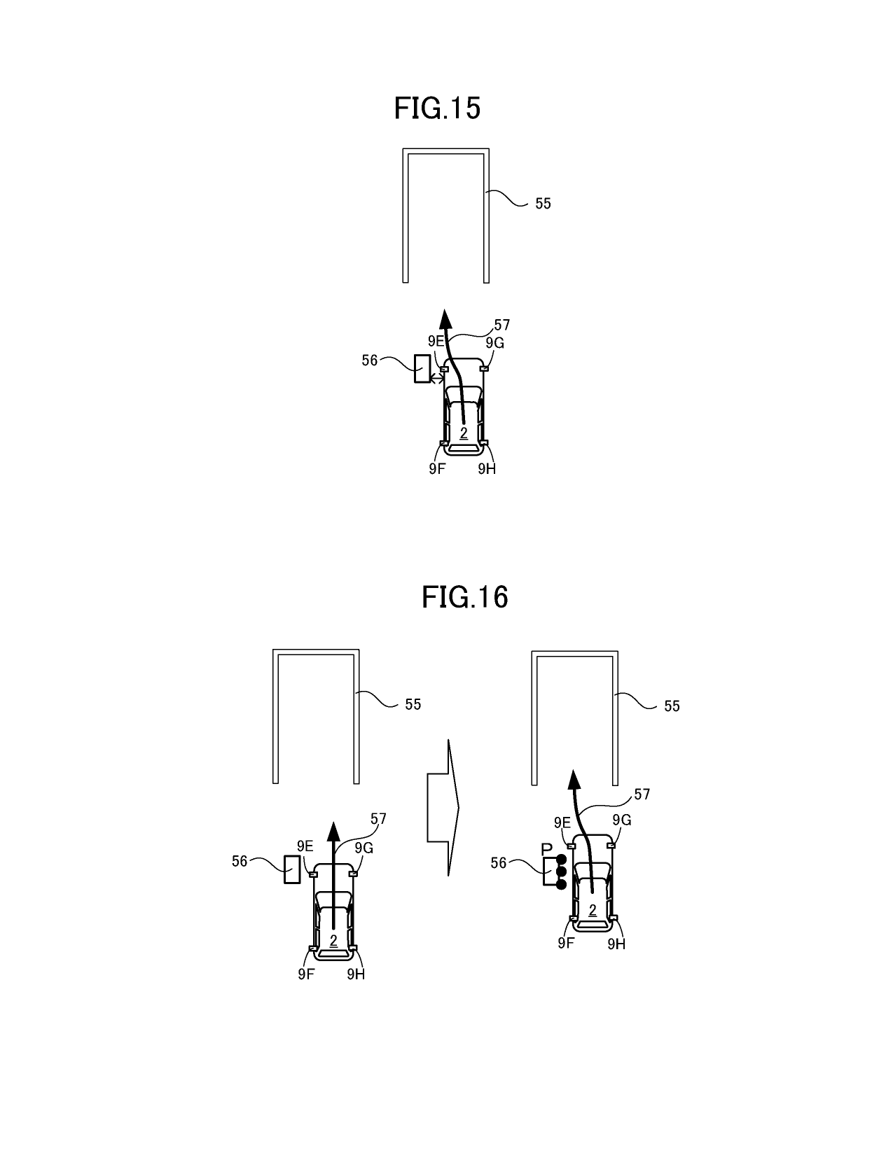

In the above description, an example of a case where parking exit assistance for a vehicle is performed is described with reference to FIGS. 7 to 14, but a similar function and effect can be obtained in a case where parking assistance for a vehicle is performed. For example, in FIG. 15, a case where parking assistance for parking the vehicle forward in the garage 55 is performed and the obstacle 56 is detected in the side direction of the vehicle at the time when the parking assistance is started will be described. In the example illustrated in FIG. 15, not the garage 55 but the obstacle 56 corresponds to a side obstacle. In this case, unless the approach to the obstacle is restricted in the generation of the travel trajectory in S3, there is a problem that the vehicle travels the travel trajectory 57 for making a left turn from immediately after the start of the assistance due to the entrance of the garage 55 detected by the camera or the like. As described above, in the present embodiment, in the generation of the travel trajectory in S3, since the approach to the obstacle 56 detected in the period from the start of the parking assistance of the vehicle until the condition in S5 is satisfied is restricted, the travel trajectory 57 for going straight to the garage 55 as illustrated in FIG. 16 is generated. Thereafter, the detailed position of the obstacle 56 is detected (or the vehicle travels a predetermined distance) by, for example, triangulation, and the restriction is released after the condition of S5 is satisfied. Finally, the travel trajectory 57 for making a turn to enter the entrance of the garage 55 is generated (S7).

As described in detail above, according to the driving assistance device 1 and the computer program executed by the driving assistance device 1 according to the present embodiment, an obstacle is detected based on the result of detection by the ultrasonic sensors 9E to 9H included in the vehicle during parking assistance or parking exit assistance of the vehicle. In addition, a plurality of the ultrasonic sensors 9E to 9H is installed at the side face of the vehicle 2 in a positional relationship in which indirect waves are not allowed to be received from each other. In a case where a side obstacle is detected in the side direction of the vehicle by the ultrasonic sensors 9E to 9H at the time of starting the parking assistance or the parking exit assistance of the vehicle, the approach to the side obstacle detected in a period from the start of the parking assistance or the parking exit assistance of the vehicle until the predetermined condition is satisfied is restricted (S3, S4). Therefore, in a situation in which the accuracy of detection of the obstacle is low immediately after the start of the assistance, it is possible to prevent the behavior of approaching the obstacle based on the result of detection with low accuracy from being performed. In addition, a behavior that cannot be understood by the user, such as approaching another obstacle in order to avoid an obstacle that does not exist, is not indicated, and the user is not concerned. In addition, it does not lead to the situation where correction of the trajectory is impossible in the parking assistance or the parking exit assistance thereafter.

In addition, in the detection of the obstacle based on the ultrasonic sensors 9E to 9H, the position of the obstacle is allowed to be identified by triangulation using measurement distances from a plurality of different vehicle positions associated with the movement of the vehicle and the movement distance, of the vehicle, between the different vehicle positions, and the predetermined condition is that the position of the side obstacle detected by the distance measurement sensor at the time when the parking assistance or the parking exit assistance of the vehicle is started is allowed to be identified by triangulation (S5). Therefore, in a situation where the triangulation is established after the start of the assistance and the accuracy of detection of the side obstacle can be sufficiently ensured, it is possible to perform the parking assistance or the parking exit assistance of the vehicle based on the result of detection of the side obstacle.

In addition, the predetermined condition is that the vehicle has traveled a predetermined distance after the parking assistance or the parking exit assistance of the vehicle is started (S5). Here, in a case where the triangulation has not been established for an indefinite time for some reason, when the establishment of the triangulation is set as a predetermined condition, there is a possibility that the vehicle continues traveling straight and an obstacle (the obstacle 56 illustrated in FIG. 12) to be avoided cannot be avoided. However, it is possible to avoid the obstacle by setting the travel distance as a condition.

In addition, in a case where a side obstacle is detected by at least one or more ultrasonic sensors among the plurality of ultrasonic sensors 9E to 9H installed in the vehicle at the time when parking assistance or parking exit assistance of the vehicle is started, the approach to the obstacle detected by each of all the ultrasonic sensors, each ultrasonic sensor having detected the side obstacle, is restricted (S3). Therefore, by not limiting the object to a specific ultrasonic sensor, it is possible to restrict the approach to the side obstacle outside the detection range of the traveling direction side sonar.

In addition, in a case where a side obstacle is detected by the ultrasonic sensors 9E to 9H at the time when parking assistance or parking exit assistance of the vehicle 2 is started, even in a case where it is detected that an obstacle other than the side obstacle is further present in the traveling direction of the vehicle 2 by a sensor or a camera whose detection range is a range in the traveling direction of the vehicle 2, the approach to the side obstacle is restricted in a period from the start of parking assistance or parking exit assistance of the vehicle 2 until a predetermined condition is satisfied. As a result, even when there is an obstacle in the traveling direction of the vehicle, it is possible to prevent a behavior of approaching the side obstacle until a predetermined condition is satisfied.

### Supplementary note

The embodiments described above also disclose the following inventions. In the following description, names and expressions of corresponding configurations in the embodiment and reference numerals used in the drawings are added in parentheses for reference. However, the components of each invention are not limited to this supplementary note.

### Invention A

The driving assistance device (1) according to claim 2, wherein a plurality of the distance measurement sensors (9E to 9H) is installed at different positions with respect to the vehicle (2), and the predetermined condition is that, in a case where the side obstacle is detected by the plurality of distance measurement sensors installed in the vehicle at a time when parking assistance or parking exit assistance of the vehicle is started, the position of the side obstacle is allowed to be identified by the triangulation using a measurement distance by a foremost distance measurement sensor in a traveling direction of the vehicle among a plurality of distance measurement sensors that has detected the side obstacle.

According to this, it is possible to perform the parking assistance or the parking exit assistance of the vehicle by trusting the result of detection of the obstacle in a situation where at least the accuracy of detection of the obstacle at the traveling direction side location of the vehicle can be sufficiently secured.

### Invention B

The driving assistance device (1) according to claim 1, wherein the driving assistance device generates a future travel trajectory (57) of the vehicle along a traveling direction of the vehicle using a result of detection by the distance measurement sensors (9E to 9H) when performing parking assistance or parking exit assistance of the vehicle (2), and performs control for moving the vehicle according to the generated travel trajectory, and generating the travel trajectory includes in a case where the side obstacle is detected by the distance measurement sensor at a time when the parking assistance or the parking exit assistance of the vehicle is started, generating a travel trajectory in which approach to the side obstacle is restricted in a period from a time when the parking assistance or the parking exit assistance of the vehicle is started until a predetermined condition is satisfied.

According to this, in a situation where the accuracy of detection of the obstacle is low immediately after the start of the assistance, it is possible to prevent the travel trajectory in which the vehicle approaches the obstacle based on the result of detection with low accuracy from being generated. In addition, a travel trajectory that cannot be understood by the user, such as approaching another obstacle in order to avoid an obstacle that does not exist is not formed, and the user does not have a concern. In addition, it does not lead to the situation where correction of the trajectory is impossible in the parking assistance or the parking exit assistance thereafter.

### Invention C

The driving assistance device (1) according to the invention B, wherein the travel trajectory (57) in which the approach to the side obstacle is restricted is generated on condition that the side obstacle is detected within a predetermined detection distance from the vehicle by the distance measurement sensor at a time at which parking assistance or parking exit assistance of the vehicle (2) is started, and the detection distance is longer than a distance from the vehicle to an obstacle, the distance being allowed at the time of generating the travel trajectory.

According to this, a state is maintained in which the distance to the side obstacle detected at the time of starting the parking assistance or the parking exit assistance of the vehicle is longer than the distance allowed to approach the obstacle, and the subsequent travel trajectory is generated. As a result, it does not lead to the situation where the distance to the side obstacle exceeds the allowable range and the trajectory cannot be corrected.

It should be noted that the present invention is not limited to the above embodiments, and various improvements and modifications can be made without departing from the gist of the present invention.

For example, in the present embodiment, the occupant outside the vehicle starts the parking assistance and the parking exit assistance by designating the traveling direction of the vehicle by the remote controller 39, but the start conditions of the parking assistance and the parking exit assistance are not limited to the above examples, and it is possible to perform the parking assistance and the parking exit assistance in a state where the occupant is in the vehicle.

Further, in the present embodiment, it is determined whether an obstacle has been detected by the ultrasonic sensors 9E to 9H whose detection range is particularly a range in a side direction of the vehicle among the ultrasonic sensors 9A to 9L in the above-described S2, but it may be determined whether an obstacle has been detected including an ultrasonic sensor other than the ultrasonic sensors 9E to 9H. In this case, when an obstacle is detected around the vehicle other than in the side direction of the vehicle, the approach of S3 may be restricted with respect to the obstacle.

Further, in the present embodiment, as the parking assistance and the parking exit assistance of the vehicle, the parking assistance for parking the vehicle in the garage 55 which is a closed space as illustrated in FIGS. 7 to 16 and the parking exit assistance for exiting the vehicle from the garage 55 have been described as examples, but the parking assistance and the parking exit assistance for the parallel parking of the vehicles in a general open parking lot can be similarly performed. In addition, parking assistance and parking exit assistance for tandem parking can be similarly performed.

In the present embodiment, the process of the driving assistance processing program (FIG. 5) is configured to be executed by the driving assistance ECU 10 of the driving assistance device 1, but the entity that executes the process can be appropriately changed. For example, the process may be configured to be executed by the control unit of the liquid crystal display 4, the vehicle control ECU, the control unit of the navigation device, and other in-vehicle devices.

What is claimed is:

1. A driving assistance device that detects an obstacle based on a result of detection by a distance measurement sensor included in a vehicle during parking assistance or parking exit assistance of the vehicle, wherein
the distance measurement sensor includes a plurality of the distance measurement sensors installed at a side face of the vehicle in a positional relationship in which indirect waves are not allowed to be received from each other, and wherein
in a case where a side obstacle is detected as the obstacle in a side direction of the vehicle by the distance measurement sensor at a time when parking assistance or parking exit assistance of the vehicle is started, the driving assistance device restricts approach to the side obstacle in a period from when the parking assistance or the parking exit assistance of the vehicle is started until a predetermined condition is satisfied.

2. The driving assistance device according to claim 1, wherein
in detection of an obstacle based on the distance measurement sensor, a position of the obstacle is allowed to be identified by triangulation using measurement distances from a plurality of different vehicle positions associated with a movement of the vehicle and a movement distance, of the vehicle, between the different vehicle positions, and wherein
the predetermined condition is that a position of the side obstacle detected by the distance measurement sensor at a time when parking assistance or parking exit assistance of the vehicle is started is allowed to be identified by the triangulation.

3. The driving assistance device according to claim 1, wherein the predetermined condition is that the vehicle has traveled a predetermined distance after parking assistance or parking exit assistance of the vehicle is started.

4. The driving assistance device according to claim 1, wherein in a case where the side obstacle is detected by at least one or more distance measurement sensors among the plurality of distance measurement sensors installed in the vehicle at a time when parking assistance or parking exit assistance of the vehicle is started, approach to the side obstacle detected by each of all the distance measurement sensors, each distance measurement sensor having detected the side obstacle, is restricted.

5. The driving assistance device according to claim 2, wherein in a case where the side obstacle is detected by at least one or more distance measurement sensors among the plurality of distance measurement sensors installed in the vehicle at a time when parking assistance or parking exit assistance of the vehicle is started, approach to the side obstacle detected by each of all the distance measurement sensors, each distance measurement sensor having detected the side obstacle, is restricted.

6. The driving assistance device according to claim 3, wherein in a case where the side obstacle is detected by at least one or more distance measurement sensors among the plurality of distance measurement sensors installed in the vehicle at a time when parking assistance or parking exit assistance of the vehicle is started, approach to the side obstacle detected by each of all the distance measurement sensors, each distance measurement sensor having detected the side obstacle, is restricted.

7. The driving assistance device according to claim 1, wherein
in a case where the side obstacle is detected by the distance measurement sensor at a time when parking assistance or parking exit assistance of the vehicle is started,
even when a sensor or a camera whose detection range is a range in a traveling direction of the vehicle detects that an obstacle other than the side obstacle is further present in the traveling direction of the vehicle,
approach to the side obstacle is restricted in a period from when parking assistance or parking exit assistance of the vehicle is started until a predetermined condition is satisfied.
